(19) United States
(12) Patent Application Publication
(10) Pub. No.: US 2004/0011568 A1
(43) Pub. Date: Jan. 22, 2004

(54) Combination scale for weighing long shaped loose products, such as pasta or similar

(76) Inventors: Piero Brogi, Firenze (IT); Pierpaolo Brunini, Pistoia (IT)

Correspondence Address: McGlew & Tuttle, Scarborough Station, Scarborough, NY, 10150-0827, US

(21) Appl. No.: 10/297,396

(22) PCT Filed: Jun. 1, 2001
(86) PCT No.: PCT/IT01/00281

(30) Foreign Application Priority Data
Jun. 7, 2000 (IT) FI2000A000128

(51) Int. Cl. G01G 13/02

(52) U.S. Cl. 177/119

(57) ABSTRACT

The scale comprises: a rough weighing section with at least one rough weighing head (9, 11) and a weighing means (25, 27) for weighing individual rough weight amounts of a loose product; a finishing section (2) with a plurality of weighing means (35, 37) for weighing individual amounts of the loose product; a control unit (41) determining, for each rough amount, a combination of said individual amounts of product weighed in the finishing section which sum is a finishing amount that added to the respective rough amount optimally approximates a predetermined nominal amount.

### TECHNICAL FIELD

This invention relates to a scale for weighing loose product, specifically long shaped, such as, for example, long pasta, such as spaghetti or similar.

### STATE OF THE ART

Currently, apparatuses known as combination scales are used for weighing small sized loose food products, specifically short pasta. These machines comprise a plurality of weighing heads, normally arranged around a hopper. Each weighing head receives a quantity of product, which weight corresponds to a fraction of the total weight of the product for each package. By means of a specific programmed control system, a sub-set of heads, providing the best approximation of the predetermined weight of the product to be packed, is selected. The selection is made considering the need to ensure an amount of product in each package which is at least equal to the nominal amount. This is because rounding down is not allowed, since this would be a fraud, and rounding up considerably exceeding the nominal weight of the package would cause severe economic loss for the manufacturer.

For this reason, progressively more perfected scales for obtaining increasingly more accurate food product weighing halve been devised, still safeguarding the consumers. Examples of combination scales for short shaped pasta are described in U.S. Pat. Nos. 4,418,771 and 4,398,612. Other examples of combination scales for loose products are described in European Patents 0,074.261, 0.074.813, 0.076.167, 0,064.554, 0.160.512, 0.101.314, 0.124.370.

These types of scales cannot be used for weighing long shaped products, for example spaghetti or other long shaped pasta. This is because this type of product cannot be handled with a plurality of heads arranged in circle around the hopper in which the various heads selected by the control program pour the product, because this would break the product and jam the machine.

Consequently, for weighing spaghetti and other long shaped pasta, scales are used in which a first weighing head performs a rough weighing, with which a rough amount corresponding to an amount of product lower than the predetermined weight to be packed is determined. A finishing amount of product, determined by volume, is then added to the rough amount. This is obtained by means of a long narrow channel in which an amount of long shaped pasta, or other loose product to be packed, is arranged. The cross dimension of the channel is sufficiently small to consider that the product contained in a portion of the channel has a weight which is approximately proportional to the volume of the portion of the channel. Finishing is obtained by volume, meaning that an amount of product from the channel determined by cutting off a portion of the channel, which volume roughly corresponds to the weight required to reach the nominal weight of the package, rounded up as required, from the rough amount, is poured into the package.

These scales present some considerable problems. Firstly, volumetric determination of the finishing amount is not adequately accurate. This entails considerable economic loss for the manufacturer. The accuracy of weighing is effected also by the quality of the product.

Furthermore, the need to cut off portions of the channel to identify the amount of product to be poured into each package by volume entails the need to use blades, which penetrate in the channel crossing it and interfering with the loose product it contains. This frequently breaks the loose product and causes packaging problems, also when soldering the package for the presence of broken products (e.g. spaghetti) which interfere with the soldering machine which closes the film with which the package is made, in addition to causing problems in terms of quality and appearance.

### OBJECTS AND SUMMARY OF THE INVENTION

The object of this invention is to provide a scale which is suitable for weighing loose product, also long shaped, such as pasta or similar, overcoming the problems of traditional scales of these applications, and which can be designed with a limited size.

These and additional objects and advantages, which will be clearly understood by those skilled in the art by reading the following text, are obtained by a combination scale comprising:

a rough weighing section, with at least one rough weighing head and a weighting means for weighing individual amounts of a loose product;

a finishing section with a plurality of weighing means, which weigh individual amounts of loose product;

a control unit, which determines, for each rough amount, a combination of said individual amounts of weighed product in the finishing section, which sum determines a finishing amount which, summed to the respective rough amount, optimally approximates a predetermined nominal weight.

With a scale of this type, the predetermined weight, which is destined, for example, to form a single package of product, is reached by suitable approximation (normally by rounding up) obtained integrally by the determining the weight of the amount of product instead of the volume, at least in part, as in traditional scales for weighing long shaped products, such as long pasta. In this way, a greater weighing accuracy is obtained and the need to use blades for cutting off the predetermined volumes of product is eliminated, whereby eliminating the problems deriving from the use of these mechanical parts, which damage the product in traditional scales with volumetric determination of the finishing amounts.

The use of a rough weighing station and a finishing station permits a substantial reduction of the overall size of the machine.

In practice, the scale according to this invention permits a weighing method including of the following phases:

weighing a rough amount of loose product comprising an amount of product which weight is lower than a predetermined weight,

weighing a plurality of individual amounts of product, each of which contains an amount of product, which weight is equal to a fraction of the difference between the predetermined weight and the rough amount,

selecting a combination of said individual amounts of product, which sum forms a finishing amount which, added to the rough amount, is an optimal approximation of said predetermined weight,

joining said rough amount to said finishing amount.

According to a particularly advantageous form of embodiment of the invention, the scale comprises a conveyor equipped with a plurality of cups for receiving the rough amounts and the finishing amounts of lose product from the rough weighing section and the finishing section, which are both crossed by the conveyor. The latter can be a linear conveyor, for example a chain or a belt conveyor, on which the individual cups are arranged. Alternatively, other types of conveyors may be used, for example rotating conveyors. The cups are any sort of container, in which the weighed product can be collected. The cups can be made also in the form of rocking cradles hinged, for example, on a conveyor chain, with suitable systems for rocking the cradles in the position in which the weighed product is unloaded, typically into a packaging machine.

The conveyor is used to collect the rough amount and the finishing amount of the product in a mobile cup, thus handling the product in such a way to prevent mechanical stress and breaking the product.

In order to obtain a particularly high productivity rate, according to a particularly advantageous embodiment of the invention, the rough weighing section comprises at least two rough weighing heads side by side, each of which is equipped with a respective weighing means. In this way, the individual rough amounts from the two weighing heads can be unloaded alternatively in the cups of the conveyor.

In a possible form of embodiment of the scale, the finishing section can comprise a plurality of weighing hoppers, under which an unloading system (39; 43) for unloading the individual amounts of product, weighed in the hoppers and selected by said control unit—according to the optimal combination of reaching the predetermined weight—, into the corresponding cups where the corresponding rough amounts were previously unloaded. The unloading system may be configured in various ways. For example, it may consist of a set of suitably controlled conveyors arranged in space so to unload the product in the correct cups. According to a particularly advantageous form of embodiment, for constructive simplicity and reliability, the unloading system comprises a plurality of cascading flaps. These can be split into two or more groups, each of which presents a variable number of levels on which the flaps are arranged, according to the position which each group assumes along the development of the conveyor carrying the individual cups.

Additional advantageous characteristics and forms of embodiment of the combination scales and the respective weighing method are described in the accompanying claims.

### BRIEF DESCRIPTION OF THE DRAWINGS

This invention will be better understood by the following detailed descriptions with reference to the accompanying drawing which shows a non-limiting practical embodiment of the invention. More particularly:

FIG. 1 is a front schematic view of the scale according to the invention,

FIG. 1A is an enlarged detail of FIG. 1,

FIG. 2 is a detail of the scale in FIG. 1 in a different position of the product dispensing units of in the rough weighing head,

Figures from 2 to 9 show the scale in different instances of a weighing phase,

FIG. 10 is an alternative form of embodiment of the rough weighing section,

FIG. 11 is a modified form of embodiment of a detail of the rough weighing section,

FIG. 12 is a front schematic view of the scale according to the invention in a different form of embodiment and

FIG. 13 is an enlargement of the finishing section of the scale in FIG. 12.

### DETAILED DESCRIPTION OF THE INVENTION

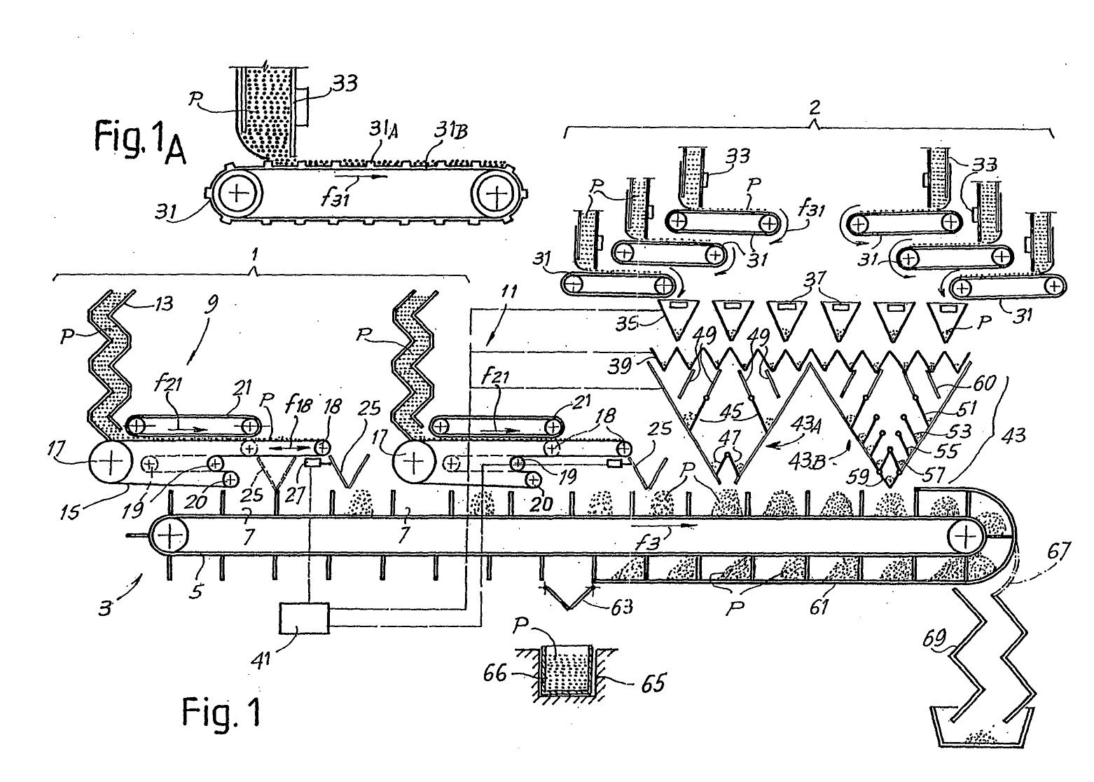

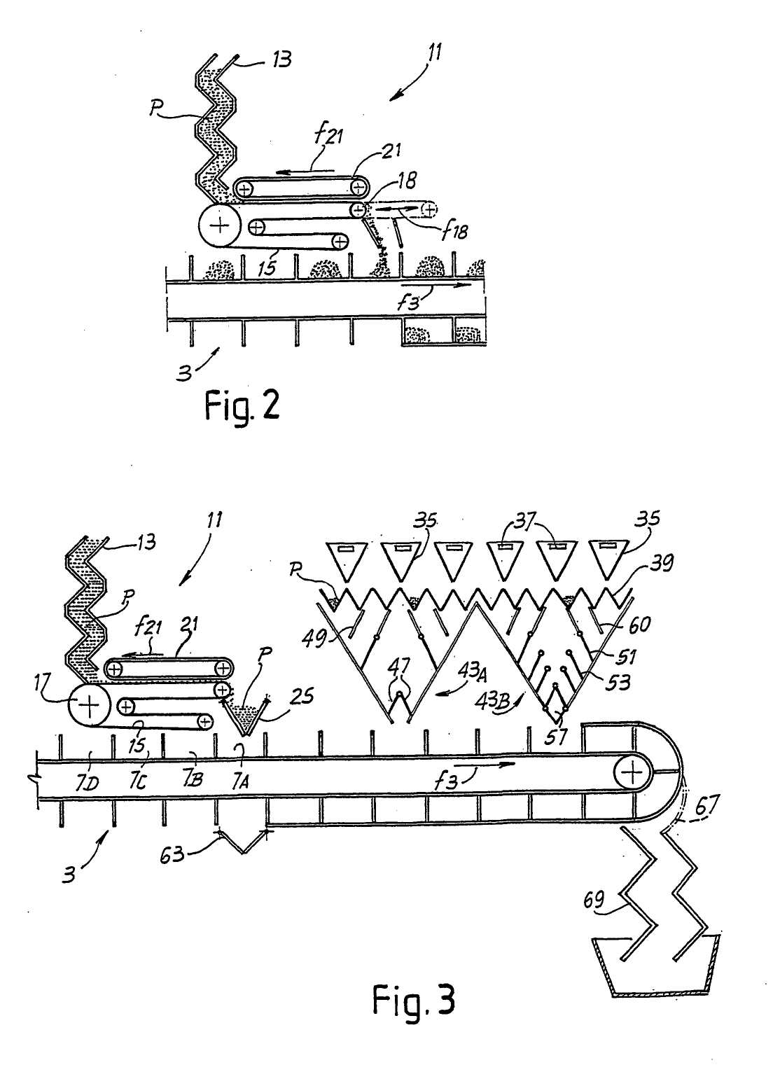

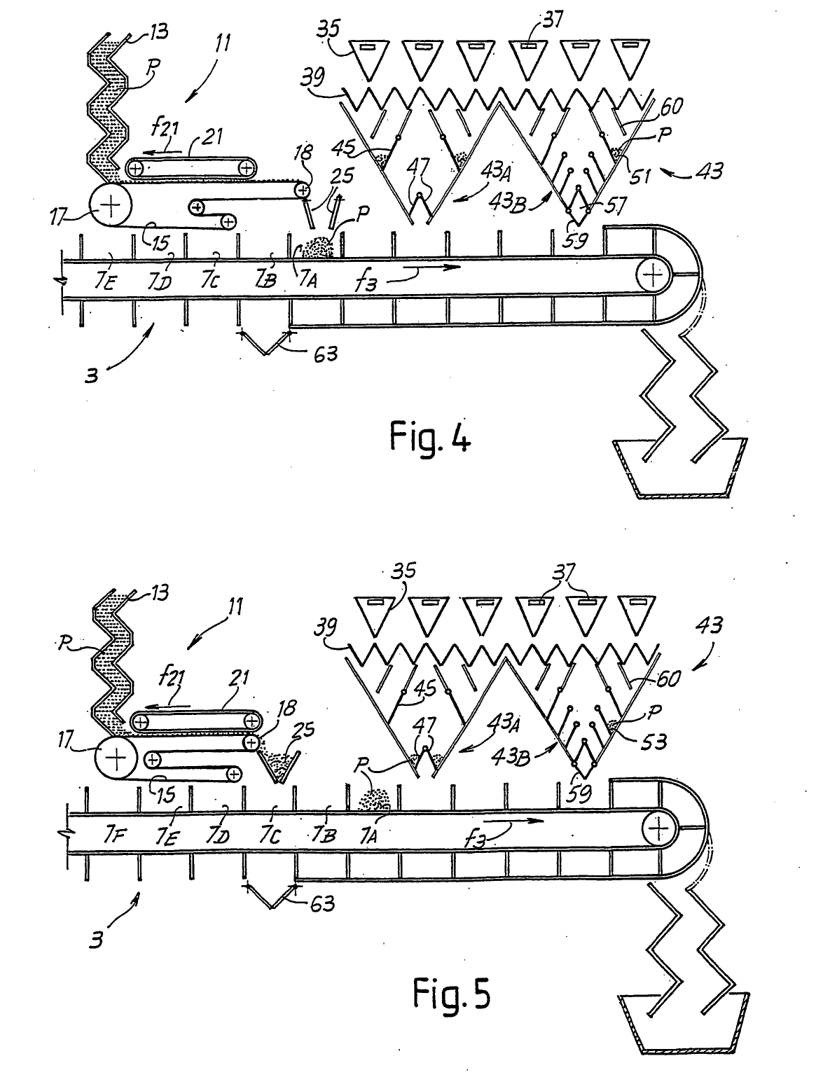

With initial reference to FIGS. 1 and 2, the scale comprises a rough weighing section, generally indicated with numeral 1, followed by a finishing section, generally indicated with numeral 2. A conveying member 3, consisting of a flexible member 5 carrying a plurality of housings or cups 7, in which the product for the individual packages is poured, is arranged under sections 1 and 2 of the scales.

The rough weighing section 1 comprises, in the example shown, two identical rough weighing heads, indicated with numerals 9 and 11, respectively. Each rough weighing head 9 and 11 comprises a descent member 13 where the loose product to be packed, indicated with P, is arranged. This is practically a channel which development is vertical and zigzagged for a gradual descent of the loose product by gravity.

A belt 15, wrapped around pulleys 17, 18, 19, 20, is arranged under each descent member. A mat 21 is arranged over the upper length of the belt 15, in an approximately parallel position. The pulley 18 moves alternatively according to the arrow f and can assume two extreme positions, shown by the solid line and the dotted line in FIG. 1 and alternatively shown by the dotted line and the solid line in FIG. 2. The belt 15 is held taut during the alternating movement of the pulley 18 by a corresponding movement of the pulley 19. During the movement of the belt 15 from left to right (seen in the figure) of the pulley 18, the mat 21 is also moved according to the arrow f21 (FIG. 2).

As appears by comparing FIGS. 1 and 2, when the pulley moves from right to left, the loose product P on the upper length of the belt 15 drops from the belt into the hopper 25 underneath, which follows the movement of the pulley 18 thus accompanying the front of the belt 15 and receiving the product falling from the belt. A load cell, schematically indicated with numeral 27, is associated to the mobile hopper 25 and determines the weight of the loose product P, which is poured from the belt 15 into the hopper 25 at each movement of the pulley 18 from right to left. During the opposite movement, from left to right of the pulley 18, and consequently of the front of the belt 15, the mat 21 is moved according to the arrow f21, and, in this way, the upper length of the belt 15 receives new loose product P from the descent member 13. This new product will be poured into the hopper 25 at with the subsequent movement from right to left of the pulley 18.

The loose product P received from the hopper 25 is unloaded, at each reversed movement from left to right of the pulley 18, into a corresponding cup 7 of conveyor 3. For this purpose, the movement from left to right of the pulley 18, and consequently of the hopper 25, is synchronised with the advancement movement according to the arrow f3 of the conveyor 3.

The movements of the rough weighing heads 9 and 11 is coordinated so that the two heads 9 and 11 unload the product they contain in cups 7 arranged in alternative positions.

The finishing section 2 presents a set of six conveyor belts, indicated by numeral 31, each of which is associated with a descent member 33 by means of which the loose product P is distributed on the corresponding conveyor belt 31. The latter presents (see detail in FIG. 1A), a surface structure with a set of ribs 31A, defining channels 31B, in which the loose product P is distributed. The arrangement ensures that a very limited amount of product is distributed in the channels 31B, up to a single piece of spaghetti in each channel (in the case of spaghetti processing). In this way, the amount of loose product which each conveyor belt 31 pours into a corresponding lower hopper 35 can be controlled rather accurately. In order to form individual amounts of product of variable weights to allow a correct combination, the various conveyors belts 31 are advanced by different and random entities for the individual hoppers 35. This is easily obtained by electronically controlling stepper motors used to drive the conveyor belts.

Each hopper 35 is associated with a respective load cell 37, which determines the weight of product which each conveyor belt 31 pours each time into the corresponding hopper 35.

Each of the six hoppers 35 can pour the loose product received from the corresponding conveyor belt 31 into either one or the other transit containers 39. This is obtained simply by opening either one or the other slanted wall of each individual hopper 35. The system managing the scale controls the finishing section so to measure the weight of the loose product poured into each of the twelve transit containers 39. The weighed amounts of loose product in the twelve transit containers 39 can be combined in various ways to be summed to the individual rough amounts, which either one or the other rough heads 9 and 11 poured into the individual cups 7 of the conveyor 3. In order to obtain the optimal combination, each hopper 35 receives an amount of product corresponding, for example, to approximately one third of the finishing amount, i.e. to the weight of the product which must be added to the rough amount to reach the predetermined weight, corresponding to the amount of product for each package.

Essentially, the control unit 41 of the scale knows the weight of the amount of loose product in each of the individual cups 7 (rough amount) at any time, as well as the weight contained in the individual transit containers 39 and makes a combination e.g. of three transit containers 39. The combination is made by selecting the three transit containers 39 containing in total the weighed amount of loose product (finishing amount) which allows the optimal approximation of the predetermined product weight, destined to each individual package, after summing to the amount determined in the rough weighing section.

Essentially, the finishing section 2 is a combination scale, which however provides the finishing amount, which is determined according to the previously weighed rough amount in the rough weighing section, instead of the total product weight destined to each individual package.

A set 43 of controlled flaps, split into two groups 43A and 43B, for pouring (in a manner to be described later) the amount of product provided by the transit containers 39, selected at each combination and forming the finishing amount, into the cups 7 to be summed to the rough amount determined in the rough weighing section 1, are arranged under the transit containers 39.

More specifically, group 43A presents a pair of flaps 45 and a lower pair of flaps 47. Furthermore, fixed baffles 49 are provided. The group 43B presents a similar arrangement, with the difference of presenting five pairs of flaps on five distinct levels, indicated with numerals 51, 53, 55, 57 and 59. Four baffles 60, similar to the baffles 49 in group 43A, are arranged over the upper pair of flaps 51.

A containing wall 61 for leading the individual cups 7 in the lower area of the conveyor 3 without spilling out the loose product P they contain develops along the lower length of the conveyor 3. The containing wall 61 develops to a lower hopper 63 arranged in an area which corresponds approximately to the middle of the conveyor 3 along the lower length. The loose product P contained in each individual cup 7 is unloaded into the lower hopper 63 by advancing the conveyor 3. After receiving the product from an individual cup, the lower hopper opens to unload the product into a channel 65 of a packaging machine of a type known per se, not shown. A flap 67 (normally closed, which shape completes the containing wall 61) is arranged in the extremity area of the conveyor 3, where the product passes from the upper length to the lower length of the conveyor. The flap 67 can be opened to make the individual cups 7 communicate with an evacuation descent member 69. This arrangement can be used to recover the loose product P which is inside the scale when the process is interrupted for any reason. In this case, the flap 67 is opened and the conveyor 3 is run until all the product contained in the cups is unloaded into the descent member 69. The flap 67 can also be used to unload individual wrong weighed amounts from the cups 7.

Figures from 4 to 9 schematically illustrate the operating method of the scale described in the previous paragraphs, with reference to a single weighing operation. FIG. 4 schematically shows an instant in which an amount of loose product P (rough amount), which weight is determined by the load cell 27 associated to the hopper 25 of the rough weighing head 11, is poured into an individual cup, indicated with numeral 7A. The rough weighing head 11, in the instant shown in FIG. 4, is in a position in which the respective hopper 25 is empty, because the product it originally contained is in the cup 7A. The hopper 25 and the pulley 18 are in retracted position.

In the two cups next to the cup indicated with numeral 7A, a rough weighed amount is present which is poured into the cups by the weighing head 9 and is not shown for greater clarity in the drawing. Similarly, the rough amounts present in the other downstream cups are not shown.

The control unit 41 identifies, on the basis of the measurements made by the load cells 37 associated to the hoppers 35, the weights of the product in the transit containers 39. Also knowing the weight of the rough amount in the cup 7A, the control unit can select the transit containers 39 which in total contain the weighed amount of product (finishing amount), which optimally approximates the nominal weight of the package, e.g. half a kilogram, once it is added to the product contained in the cup 7A.

In the example shown, the optimal combination identified by the control unit 41 is represented by the third, fourth and tenth transit container 39, considering that the first transit container 39 is the one closer to the left in FIG. 4, i.e. the one most upstream with respect to the direction of advancement of the conveyor 3.

In the arrangement of FIG. 4, the three amounts of product contained in said transit containers were unloaded in the space delimited by the flaps 45 of group 43A and the space delimited by one of the two flaps 51 of group 43B. As will appear clear in the following figures, the number of flaps of each group 43A and 43B is chosen so to pour the product from any of the transit containers 39 into the correct cup 7 at all times regardless of the combination of transit containers 39 selected by the control unit 41 to complete the rough amount in the individual cups.

In the position shown in FIG. 5, the conveyor 3 has advanced by one step, i.e. by one cup. In this way, while cup 7B passes under the hopper 25 of the rough weighing head 11 without receiving the product because the product was received from the rough weighing head 9 (not shown here for the sake of simplicity), the cup 7C is under the hopper 25 of the rough weighing head 11, to receive the product P from the hopper, which weight was determined by the control unit 41 by means of the load cell 27. In the following phases, the pulley 18 starts advancing synchronously with the advancement of the conveyor 3 to receive new loose product from the descent member 13.

In the meantime, the flaps 45 of the group 43A were open and the loose product of the first two finishing amounts is dropped to the lower flaps 47, which withhold the product to the next step. In group 43B, the right flap 51 was opened to drop the product from the tenth transit container 39 onto the lower flap 53.

In the following FIG. 6, the conveyor 3 is advanced by an additional step and the cup 7A is under the group 43A, i.e. in a position so to receive the product which was temporarily being withheld by the flaps 47 which, in the position shown in FIG. 6, are opened to release the product into the cup 7A. In this way, the first two portions of the finishing amount identified by the control unit 41 are summed to the rough amount contained in the cup 7A.

At the same time, the front of the belt 15 defined by the pulley 18 is advanced, together with the hopper 25, so that the upper length of the belt 15 receives the product destined to determine the new rough amount to be unloaded into the cup 7E.

The flap 53 in group 43B has been opened to drop the finishing amount destined to the cup 7A onto the lower flap 55.

FIG. 7 illustrates a subsequent instant in which the cup 7A is transiting towards the group of flaps 43B, from which it must receive the third portion of the finishing amount. In this phase, the flap 55 opened and dropped the product onto the flap 57 underneath. In FIG. 8, the cup 7A is advanced by an additional step and the flap 57 has unloaded the product of the third portion of the finishing amount onto the last pair of flaps 59. The latter will open, dropping the product in the next step, shown in FIG. 9, where the cup 7A is under the flaps 59.

As appears clear in the sequence of phases illustrated in Figures from 4-9, the number of flaps in the groups 43A and 43B permits unloading the portions forming the individual finishing amounts into the correct cups, as identified by the control unit 41. For this reason, the second group 43B presents a higher number of levels, on which the respective flaps are arranged, because the area in which these unload the product into the cups 7 is more distant from the rough weighing heads 9 and 11 with respect to the unloading area of the flaps of group 43A.

FIGS. 4-9 simply illustrate the movement of the members in the second rough weighing head 11. Only the weighed product unloaded by the rough weighing head 11 is shown in the cups, numbered in sequence from 7A to 7G. The cups which appear empty (7B, 7D, 7F) actually receive the rough amounts, determined and unloaded, from the rough weighing head 9. This product is not shown in Figures from 4 to 9 to illustrate the operation of the individual rough weighing head with greater clarity.

Again for reasons of clarity, only three amounts of product related to the combination of transit containers 39 selected by the control system for forming the finishing amount which is summed to the rough amount in cup 7A to complete the weight are shown in these figures. The indication of the product contained in the hoppers 35 and in the transit containers 39, in addition to the correspondence of the various flaps under the groups 43 is also omitted. This is to make the operation of the system more comprehensible by following the movement of a single combination of product amounts destined to an individual cup. It must be understood that during this operation, respective amounts of product, which the control unit 41 combines to determine the finishing weight, are always present in the hoppers 35 and in the transit containers 39. These amounts are then gradually dropped, by suitably controlling the flaps of group 43 according to the selection made by the control unit 41 and synchronously with the advancement movement of the conveyor 3.

Furthermore, whenever the product of one of the transit containers 39 is unloaded to the lower flaps, the corresponding upper hopper 35 fills the transit conveyor again with a weighed amount of product. The control unit 41 consequently has a number of transit containers 39 sufficient to determine a suitable combination, which approximates the predetermined weight with adequate accuracy. It is clear that greater precision can be obtained by increasing the number of individual amounts of product on which the combination can be made to obtain the finishing amount. A greater number of transit containers 39 would require a greater extension of the scale in length and in height, because of a higher number of flaps for unloading the individual finishing amounts in the correct cups.

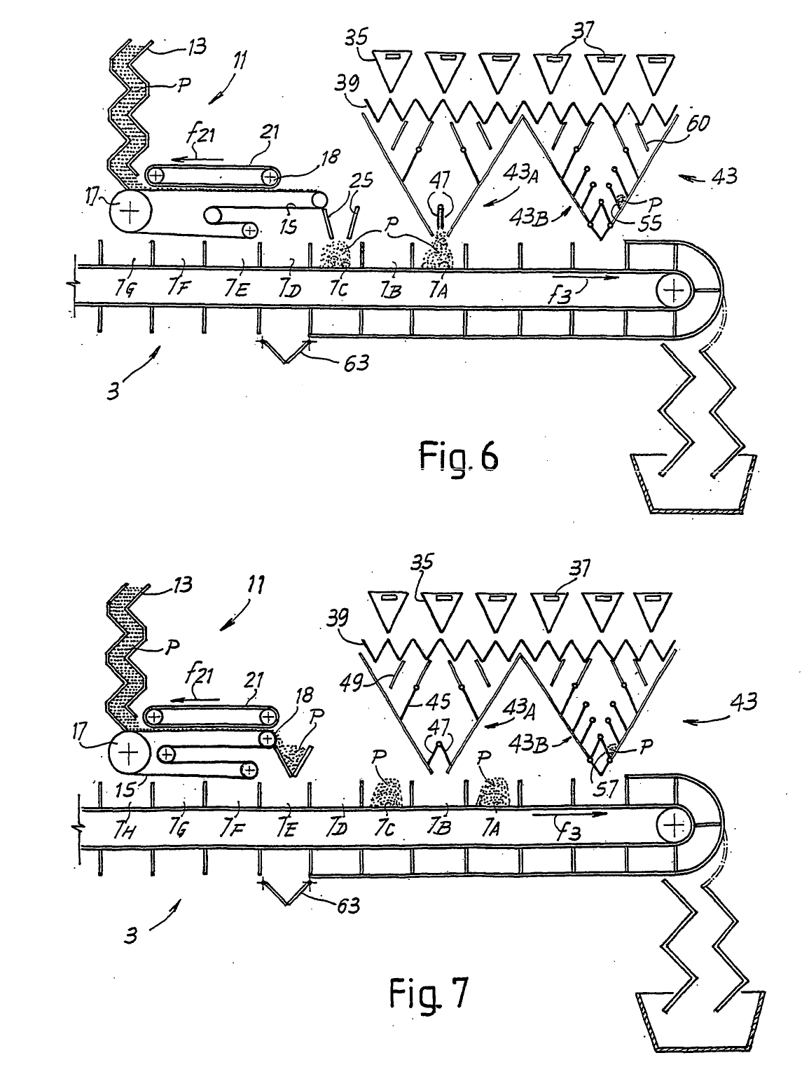

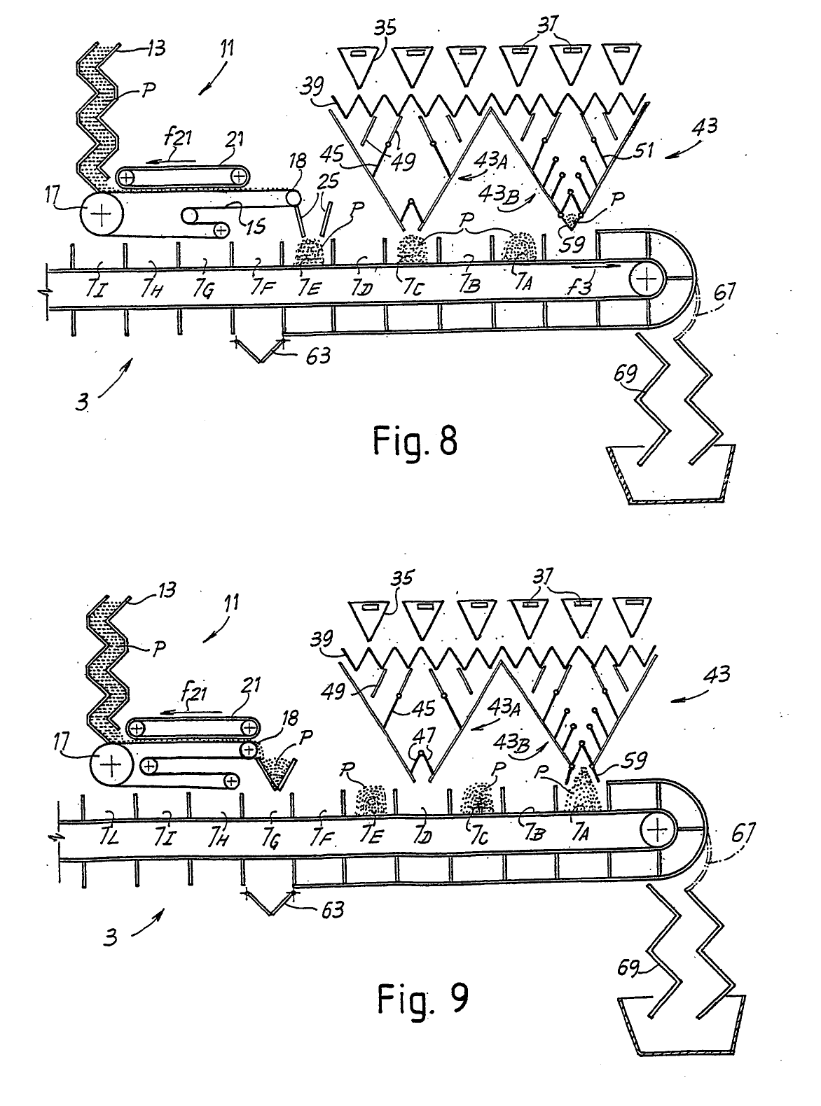

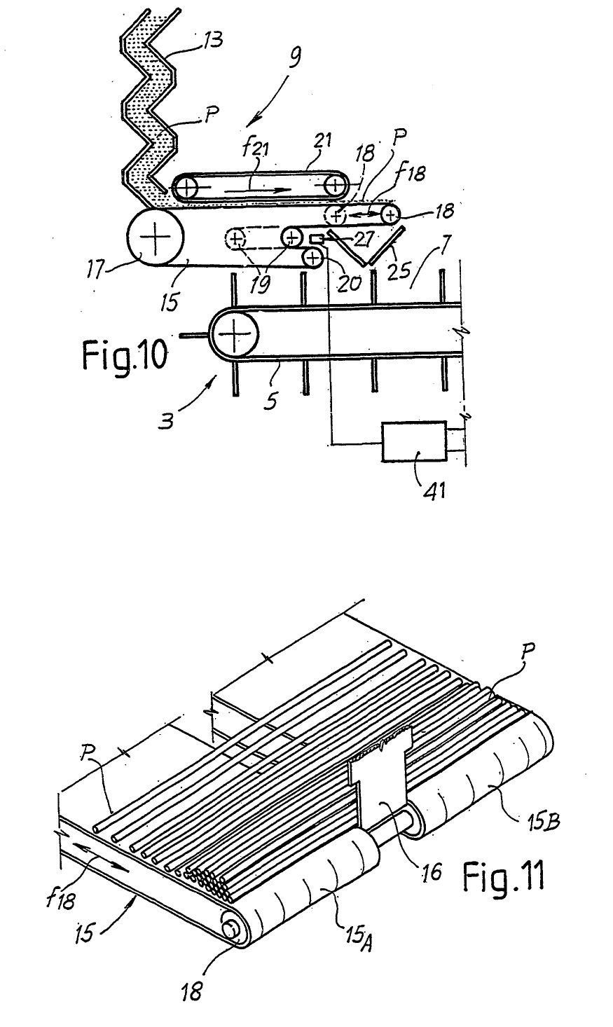

In the previous description, the hoppers 25 follow the movement of the front edge of the conveyor belt 15 integral with the pulley 18. According to a modified form of embodiment, the hoppers 25 are arranged in a fixed position and equipped with an inlet, which is sufficiently wide to receive the product from the conveyor belt 15 when the front of the belt moves in the opposite direction with respect to the conveyor 3 underneath. This solution is schematically illustrated in FIG. 10 for one of the two weighing heads. The fixed position arrangement of the hopper 25 allows for longer time for weighing.

FIG. 11 illustrates a particular form of embodiment of the belts 15. In this form of embodiment, each belt 15 is formed by two belts 15A and 15B, reciprocally parallel and distanced so to arrange a fixed stop 16 between them. This stop 16 halts the product P so that it does not fall off the belt 15 in advance with respect to the start of the retraction movement of the pulley 18.

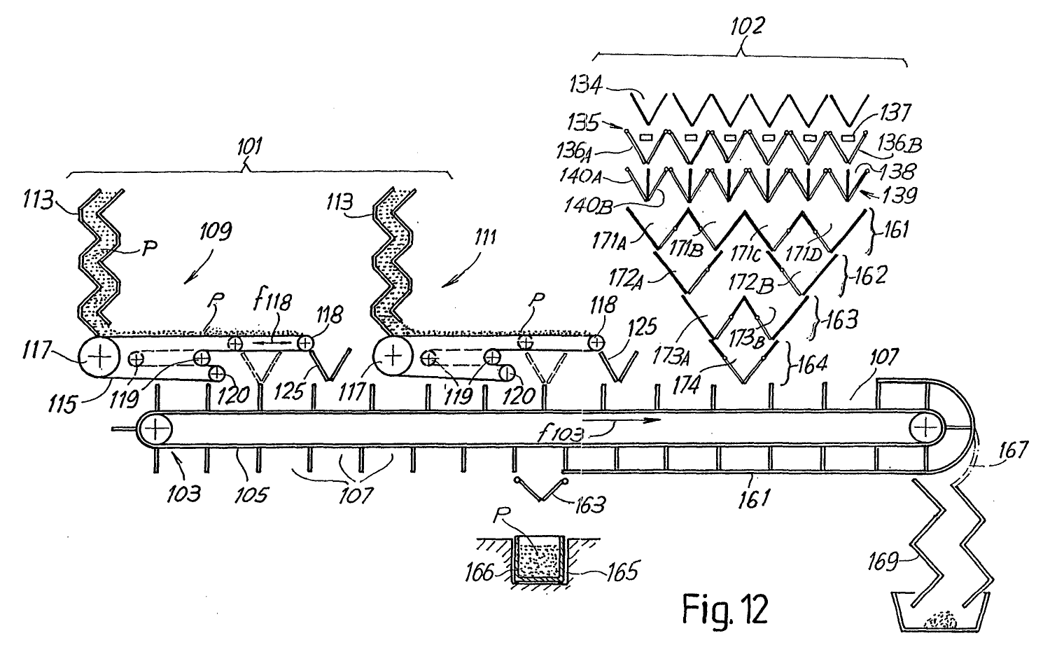

FIG. 12 illustrates a front, schematic view of a modified form of embodiment of the scale according to the invention. Equal or corresponding parts are indicated with the same reference numerals as the previous example, increased by 100. The scale comprises a rough weight section 101 followed by a finishing section 102, and a conveyor 103 underneath, split into a plurality of seats or cups 107. The rough weighing section 101 is essentially made in the same way as the rough weighing section 1 in the previous example of embodiment and will not be described in greater detail. Some parts have been omitted to simplify the drawing, e.g. the mats corresponding to the mats 21.

The finishing section 102 presents a set of conveyor belts equal to the conveyor belts 31 in the previous example of embodiment, or other loose product feeding units, not illustrated to simplify the drawing. These feeding members feed the loose product to a set of accumulation hoppers 134, absent in the previous example of embodiment. These hoppers 134 could also be omitted in this form of embodiment.

Under the accumulation hoppers 134A is arranged a corresponding number of weighing hoppers 135, equivalent to the hoppers 35, and each equipped with a load cell 137, or other member for determining the weight of the loose product dropped therein.

Transit hoppers, each split into two transit containers, defined by respective compartments made inside the transit hoppers and indicated with numeral 139, are arranged under the weighing hopper 135. The containers or compartments 139 are equivalent to the transit containers 39 in the previous example of embodiment. Each hopper is split by an intermediate partition 138 and each container or transit compartment 139 is defined, by one of the two side walls 140A and 140B of each hopper, in addition to the respective intermediate partition 138. The total number of compartments or containers 139 thus defined is, consequently, double with respect to the number of hoppers. Each compartment can be opened independently to unload the loose product down by rocking one or the other of the two side walls 140A, 140B. The product accumulated in each weighing hopper 135 can be unloaded in either one or the other transit container 139, in which the respective hopper is split by operating either one or the other side wall 136A, 136B forming each weighing hopper 135, which can pivot independently on the respective fulcrum.

Weighed amounts of loose product P are arranged in the twelve transit containers 139 as in the containers 39 in the previous example. The weighed amounts in the twelve containers can be variously combined and summed with individual rough amounts, which one or the other of the two rough heads has arranged in the individual cup of the conveyor 103. This all as described in the previous example.

A set of controlled flaps, belonging to the transit hoppers of the loose product to the discharging outlet, is arranged under the transit containers 139. The arrangement is similar to that described above, even if the arrangement of flaps is slightly different due to the fact that the finishing amounts cross the same set of flaps, instead of two separate sets of flaps arranged one downstream to the other, as described above.

More in particular, four transit hopper levels, indicated with numerals 161, 162, 163 and 164 respectively, under the twelve compartments formed by the transit containers 139. Level 161 presents four hoppers arranged side by side, indicated with numerals from 171A to 171D. Level 162 consists of two hoppers side by side and distanced, indicated with numerals 172A, 172B. The third level presents two hoppers 173A, 173B side by side and the fourth level 164 presents a single hopper 174.

The loose product from the compartments defined in the transit containers 139, which were selected by the control unit of the machine being as accurately as possible approximate to the nominal weight when summed to the correspondent rough amount, is unloaded into the four hoppers 171A-171D. From hoppers 171A-171D, the product is unloaded into the hoppers underneath 172A, 172B and so on, until it reaches the last hopper 174, from where the product (sum of the various selected finishing amounts) falls into the corresponding cup 107 of the conveyor 103 where the rough amount is found. After unloading the product from the hoppers 171A-171D, the hoppers are closed and are ready to receive new product from the compartments on top.

The hoppers 171A-171D can all be opened at the same time, by means of a single motor, even if only some contain the loose product forming the selected finishing amounts. This simplifies machine construction.

The various hoppers have respective flaps, which can be opened or closed to respective release or withhold the loose product, in such a way which is similar to the flaps described in the previous example of embodiment. The number of levels 161 . . . 164 depends, as described above, on the distance (computed as number of cups 107) between the unloading outlet of the last hopper 174 and the rough amount loading area.

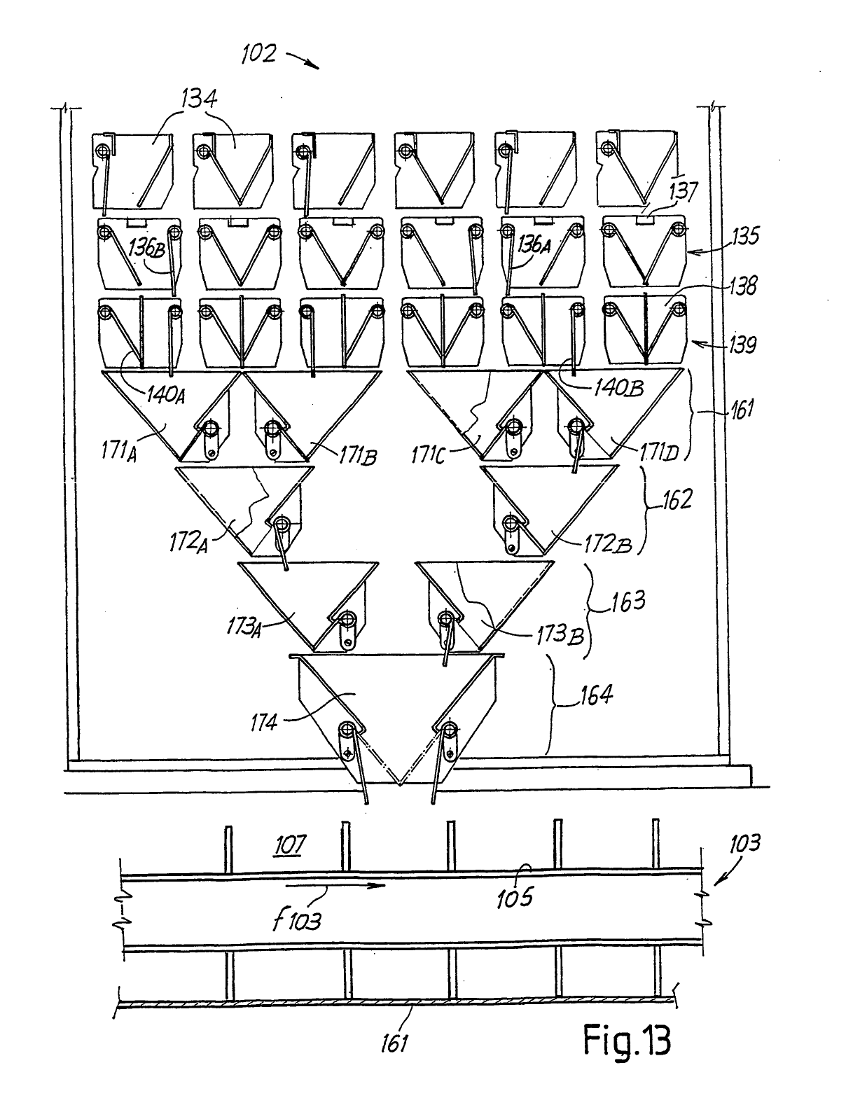

The finishing section 102, schematically illustrated in FIG. 12, is shown in greater detail in FIG. 13, where equal numbers indicate equal parts. In this figure, the various walls defining the container or compartments and the flaps of the various transit hoppers are shown in various open and closed arrangements. The configuration herein illustrated is provided as a example to show the movements which the individual units can make.

It shall be understood that the drawing only illustrates a practical form of embodiment of the invention which shape and arrangement can vary all comprised within the concept of this invention. The present of reference numerals in the following claims has the only purpose of facilitating reading the description above and the attached drawings and do not restrict the context of protection in any way.

1. A combination scale comprising:
a rough weighing section with at least one rough weighing head (9, 11; 109, 111) and a weighing means (25, 27; 125) for weighing individual rough weight amounts of a loose product;
a finishing section (2; 102) with a plurality of weighing means (35, 37; 135, 137) for weighing individual amounts of the loose product;
a control unit (41) determining, for each rough amount, a combination of said individual amounts of product weighed in the finishing section, which sum is a finishing amount that, added to the respective rough amount, optimally approximates a predetermined nominal amount;
in said finishing section (2; 102), a plurality of weighing hoppers (35; 135) and, underneath said weighing hoppers, an unloading system (39; 43; 139, 161-164) for the controlled unloading of individual amounts of product weighed in said weighing hoppers and selected by said control unit (41) in corresponding cups (7; 107) where corresponding rough weighed amounts were previously unloaded;
characterized in that said unloading system includes a plurality of transit levels (43, 45-57; 161-164) arranged in a cascade underneath said weighing hoppers.

2. Scale according to claim 1, wherein a set of transit containers (39; 139), which number is double that of the weighing hoppers (35; 135), is arranged between said weighing hoppers (35; 135) and said transit levels.

3. Scale according to claim 1 or 2, wherein said unloading system comprises a plurality of flaps arranged in a cascade (45-57), said flaps forming said transit levels.

4. Scale according to claim 1 or 2 or 3, comprising a conveyor (3; 103) equipped with a plurality of said cups (7; 107) for receiving the rough amounts and the finishing amounts of loose product (P) from said rough section and said finishing section through which said conveyors (3; 103) transits.

5. Scale according to one or more of the preceding claims, wherein said rough weighing section (1; 101) comprises at least two rough weighing heads (9, 11; 109, 111) each equipped with at respective weighing means (25, 27; 125).

6. Scale according to claim 3, wherein said cascade of flaps (45-57) are split into two groups (43A; 43B), arranged in sequence along an advancement line of said cups (7) and in which the group of flaps (43B) arranged furthermost downstream with respect to the direction of advancement of the cups presents a set of overlapping flaps arranged in a cascade (51-57) which number is higher than that of the group (43A) arranged upstream.

7. Scale according to one or more of the preceding claims, wherein said finishing section (2; 102) comprises a plurality of descent channels (33) for feeding the loose product (P) associated to respective conveyor belts (31) which unload into respective weighing hoppers (35; 135).

8. Scale according to one or more of the preceding claims, wherein said rough weighing head or heads present a descent member (13; 113) which feeds the loose product (P) to a conveying member (15-21; 115-120) which is associated to a respective rough weighing hopper (25; 125).

9. Scale according to claim 8, wherein said conveying member (15-21; 115-120) comprises a belt (15; 115), wrapped around a plurality of pulleys (17, 18, 19, 20; 117, 118, 119, 120), defining an upper length of the belt (15; 115), on which the loose product (P) from the respective descent member (13; 113) is unloaded, and from which the loose product (P) is unloaded into the respective finishing weight hopper (25; 125).

10. Scale according to claims 7 and 9, wherein the rough weighing hopper or hoppers (25; 125) are mobile, in parallel to the conveyor (3; 103).

11. Scale according to claims 7 and 9 wherein the rough weighing hopper, or hoppers, are fixed.

12. Scale according to claims 8 or 9, wherein said conveying member (15-21) presents two parallel belts (15A, 15B), between which a fixed stop (16) is arranged.

13. Scale according at least to claim 3, wherein the flaps arranged in a cascade are part of respective loose product conveying hoppers (171A-174).

14. Scale according at least to claim 2, wherein said transit containers (139) consist of pairs of compartments defined in respective transit hoppers (138), which each present two mobile lateral sides (140A, 40B), which alternatively open and close.

15. Scale according to one or more of the preceding claims, wherein said unloading system is split into five transit levels (139; 161-164), in which: a plurality of transit containers (139) is arranged in the first level, directly under the weighing hoppers (135), which number is double with respect to that of the number of weighing hoppers; a plurality of transit hoppers (171A-171D), which number is equal to one third of the number of transit containers, is arranged on the second level; a plurality of transit hoppers (172A-172B), which number is equal to half of the number of hoppers on the second level, is arranged on the third level; a number of transit hoppers (173A, 173B), which number is equal to the number of hoppers on the third level, is arranged on the fourth level; a single transit hopper (174) is arranged on the fifth level.
